(19) United States
(12) Patent Application Publication
(10) Pub. No.: US 2026/0095535 A1
(43) Pub. Date: Apr. 2, 2026

(54) IDENTIFICATION DOCUMENT AND METHODS FOR AUTHENTICATION AND MANUFACTURING OF SUCH DOCUMENT

(71) Applicant: IDEMIA Identity & Security USA LLC, Reston, VA (US)

(72) Inventor: Joseph MAYER, Reston, VA (US)

(73) Assignee: IDEMIA Identity & Security USA LLC, Reston, VA (US)

(21) Appl. No.: 19/313,171

(22) Filed: Aug. 28, 2025

(30) Foreign Application Priority Data
Sep. 30, 2024 (FR) FR2410461

(51) Int. Cl. H04N 1/32; G06K 1/12

(52) U.S. Cl. CPC H04N 1/32144; G06K 1/121

(57) ABSTRACT

A method for manufacturing an identification document including printing a background pattern on the identification document, the background pattern having contrasting motifs covering at least partly a text field of the identification document, printing an identifying information in the text field, the identifying information having one or more characters, selecting a pattern portion of an image of the identification document, the pattern portion having at least one character of the identifying information and a part of the background pattern which covers the at least one character, encoding the selected pattern portion into a machine-readable code, and printing the machine-readable code on the identification document.

### CROSS REFERENCE TO RELATED APPLICATIONS

This application claims priority under 35 U.S.C. § 119 or 365 French Patent Application No. 2410461 filed on Sep. 30, 2024. The entire contents of the above application are incorporated herein by reference.

### FIELD OF THE INVENTION

The present invention relates to documents used to identify persons or products.

### BACKGROUND OF THE INVENTION

Document authentication techniques are critical in ensuring the validity and integrity of documents across various fields, including legal, financial, and governmental sectors. These techniques encompass a range of methods designed to verify the authenticity of both physical and digital documents, safeguarding against forgery, tampering, and fraud. They not only contribute to protect sensitive information but also foster trust and reliability in document transactions and communications.

Traditional methods to perform such authentication involve for example enrollment of known security features from the design layout of a document, such as watermarks, holograms, or specialized inks.

Such approaches have long been used to secure physical documents. They are often generic to a given document type, meaning that any authentication on a given credential for a type of document will test the same features. Therefore, if a fraudster creates a fraud presentation from a known-genuine sample, the false document may inherit many to all the features used in these authentication efforts.

Meanwhile, the advent of digital technologies has introduced new solutions like digital signatures, blockchain, and biometric verification. However, these solutions also suffer from drawbacks such as complex and expensive implementation, vulnerability to cyber-attacks or privacy concerns. Moreover, integrating new digital authentication technologies with existing systems can be challenging. Ensuring compatibility and interoperability across different platforms and devices requires substantial effort and resources.

Therefore, there exists a need for authentication techniques for existing documents with improved security and resistance to fraud.

### SUMMARY OF THE INVENTION

The invention aims at improving the reliability of fraud detection for secure credential authentication systems using computer vision analysis.

To do so, it is provided a method for manufacturing an identification document, comprising the steps of
printing a background pattern on the identification document, the background pattern comprising contrasting motifs covering at least partly a text field of the identification document;
printing an identifying information in the text field, wherein the identifying information comprises one or more characters;
selecting a pattern portion of an image of the identification document, the pattern portion comprising at least one character of the identifying information and a part of the background pattern which covers the at least one character;
encoding the selected pattern portion into a machine-readable code;
printing the machine-readable code on the identification document.

The identification can be used to authenticate a person or an object securely. Indeed, during manufacturing of the identification document, a machine-readable code is printed. The printed machine-readable code encodes a pattern portion corresponding to an image comprising a character and distinguishing background pattern. During document authentication, the document may be rejected if the pattern portion on the document does not match the encoded pattern portion. This offers further possibilities to detect modified or fabricated documents.

Indeed, if the identifying information in the text field is changed, the character and the background pattern should differ from those in the encoded pattern portion, resulting in different images when authenticating the document. The solution can also be added to existing document designs to provide increased fraud detection security.

Other preferred, although non-limitative, aspects of the invention are as follows, isolated or in a technically feasible combination:
the background pattern covers the text field entirely;
the background pattern is designed as to produce a predictable binary result when a thresholding method proposed by Nobuyuki Otsu is applied;
the contrasting motifs of the background pattern do not cover the text field periodically;
the at least one character is the last character of the identifying information, and the selected pattern portion comprises a portion of the text field which follows the last character;
encoding the selected pattern portion comprises binarizing the selected pattern portion using a binarization threshold;
encoding the selected pattern portion comprises applying a compression algorithm to the selected pattern portion;
the method further comprises a step of encoding metadata information into the machine-readable code before printing the machine-readable code on the identification document, the metadata information comprising at least one among a location information of the selected pattern portion in the identification document, a security threshold for authentication of the identification document;
the method further comprises a step of cryptically signing the machine-readable code before printing the signed machine-readable code on the identification document;
the machine-readable code is printed on the identification document with a quality comprised between 200 DPI and 400 DPI;
the machine-readable code is printed at least partly with ultraviolet ink, preferably on a ghost portrait of the identification document;
the machine-readable code is a QR code.

The invention also concerns an identification document comprising at least a text field in which an identifying information is printed, wherein the identifying information comprises one or more characters and wherein a background pattern is printed on the identification document, the background pattern comprising contrasting motifs covering at least partly the text field, and

wherein a machine-readable code is printed on the identification document, the machine-readable code encoding a pattern portion of an image of the identification document which comprises at least one character of the identifying information and a part of the background pattern which covers, preferably is overlapped by, the at least one character.

The identification document is for instance, a personal identification document among a personal identity card, a driving license, or a passport.

The identification document is for instance a document to identify a product or an animal.

In another aspect, it is proposed a method for authenticating the identification document described above, comprising the steps of:
obtaining an authenticated information corresponding to a text field portion of the identification document, by decoding the machine-readable code;
extracting an input information from an image of the identification document, the extracted input information comprising the text field portion of the identification document;
comparing the extracted input information with the authenticated information, the comparison resulting in a similarity match score;
Providing an authentication result based on the similarity match score.

Typically, the authentication result is positive if the similarity match score is greater than a security threshold value, and wherein the authentication result is negative if the similarity match score is lower than the security threshold value.

Other preferred, although non-limitative, aspects of the method for authentication are as follows, isolated or in a technically feasible combination:
the method further comprises obtaining a location information by reading the machine-readable code, and the input information is extracted based on the location information;
the authenticated information is a grayscale image, and the method further comprises converting the extracted input information into a grayscale image before comparison;
the authenticated information is a black and white image, and the method further comprises obtaining a binarization threshold value by reading the machine-readable code and converting the extracted input information into a black and white image based on the binarization threshold value before the step of comparing;
the similarity match score is one among a cross correlation, a correlation coefficient, and a sum of squared differences;
the machine-readable code is encrypted using a digital signature, and the method further comprises an authentication of the machine-readable code by validating the digital signature before comparison, the authentication result being negative if the digital signature is not validated.

In another aspect, it is proposed an authentication system comprising a processor configured to carry out the method for authentication described above.

It is also considered a computer program comprising instructions, which when executed by the aforementioned authentication system, cause the authentication system to carry out the method for authentication described herein.

### BRIEF DESCRIPTION OF THE DRAWINGS

FIG. 1 represents a generic identification document of a card type.

FIG. 2 is a flow chart showing a method for manufacturing an identification document according to one aspect of the invention.

FIG. 3 is a schematic representation of the identification document of FIG. 1 after a background pattern is printed, in two embodiments.

FIG. 4 are two examples of background patterns.

FIG. 5 is a schematic representation of the identification documents of FIG. 3, wherein a pattern portion is selected.

FIG. 6 represents the selected pattern portion of one of the identification documents of FIG. 5, after binarization.

FIG. 7 is a schematic representation of encoding the selected pattern portion in an embodiment.

FIG. 8 represents the identification documents of FIG. 3, after a machine-readable code is printed.

FIG. 9 is a flow chart showing a method for authenticating an identification document according to another aspect of the invention.

FIG. 10 is a flow chart showing the method for authenticating an identification document in another embodiment.

FIG. 11 is a schematic representation a falsified identification document of FIG. 8.

FIG. 12 is a schematic representation of authenticating the falsified identification document of FIG. 11 using the authenticated information of the machine-readable code.

### DETAILED DESCRIPTION OF EMBODIMENTS

According to a first aspect is described an identification document. In the following, the identification document might simply be referred to as “document”. The identification document can be a personal identification document among a personal identity card, a driving license, or a passport. Such personal identification document can be routinely used to verify the identity of a person, referred to as the holder.

In reference to FIG. 1, is illustrated a generic national identity card. The format of the identification document is not limited to a card format but could be extended to passports or other documents attached to the identity of a person. We describe herein a personal identification document, but more generally, the identification document may be used to identify a product, an animal or any other object.

Classically, the identification document 1 comprises a picture field Pf1 wherein a picture of the holder may be printed. The identification document 1 also comprise different text fields wherein general information may be printed. By ‘general information’, it is understood the information to be printed is either not related to the holder, or not related directly and unambiguously to the holder. For instance, in the text field Atf on the top of identification document 1 is printed the authority or agency delivering the identification document. This text field may not vary from one identification document 1 to another in a same category of documents. For instance, in the text field Tf3 may be printed other general information such as a zip-code or a date of issuance or expiry of the document. This information may be identical from one identification document to another, for instance for all holders living in the same area.

The identification document 1 comprises several text fields Tf1, Tf2 wherein an identifying information is printed or to be printed. The identifying information can be a personal identification information (PII), that is any information about the holder maintained by an agency, that can be used to distinguish or trace his identity, such as name, social security number, date and place of birth, residential address. . . . The identifying information may vary in length and comprise several words separated by a blank space. The characters may comprise capital or lowercase letters, and numbers.

The identification document may be issued by a government entity, or by non-government entities, such as a contracting entity of a government agency. Manufacturing the identification document 1 is usually done using a printing machine. The printing machine is equipped with a processor configured to receive information from an interface. The printing machine may have a memory for storing information or instructions. The memory can be accessed by the processor. The interface typically comprises a scanner for scanning the printed identification document and a screen to display information. The interface can be used to input information and can comprise a keyboard for instance.

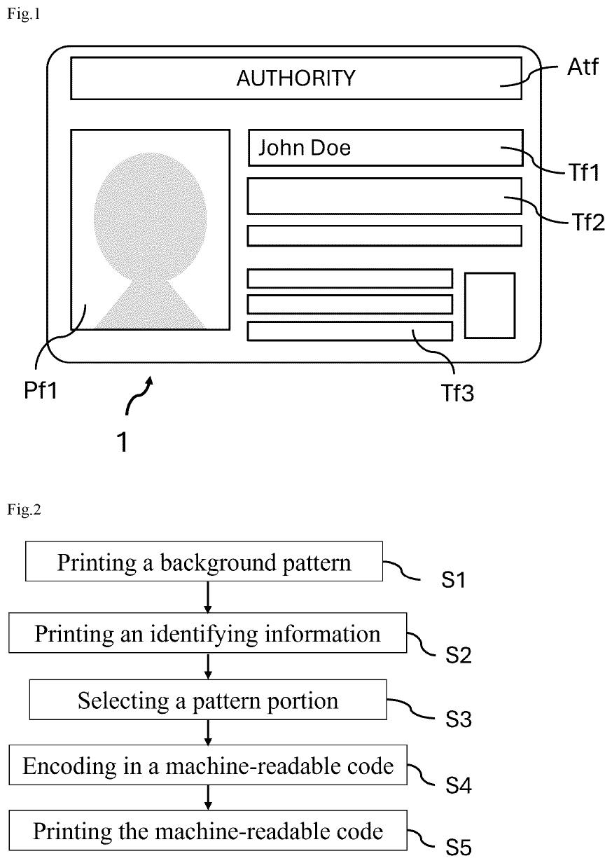

According to a first aspect illustrated in FIG. 2, a method for manufacturing a secured identification document is described.

A blank identification document is first obtained. During a step S1 of the manufacturing method, the printing machine prints a background pattern 10a, 10b on the identification document 1. During a step S2, the printing machine prints an identifying information in a text field of the identification document 1. In the illustrated examples, the text field of interest Tf1 corresponds to the full name of the holder of the document, such that the identifying information is “John Doe”. The identifying information comprises five lowercase letters and two capital letters.

Alternatively, or in combination, the identifying information may correspond to any other information distinguishing the holder of the document and comprising at least one character, for instance the last name, the first name, the document number, the address, the date of birth or the personal identification number. Therefore, the corresponding text fields have significantly variable content between holders.

The text field of interest may be identical or vary for several identification documents among a same category of identification documents. The text field of interest may be identical or vary with the identification documents across several categories.

The background pattern 10a, 10b comprises contrasting motifs covering at least partly the text field. By “covering”, it is understood that the background pattern spreads over the text field (at least partially), usually on a rectangular box, but can be underlaying or overlaying the characters printed in the text field Tf1.

The background pattern 10a, 10b is distinguishable in the sense that it differs from the background of the rest of the identification document 1a, 1b. By “contrasting motifs”, it is understood that the motifs are not blurred and do not resemble the background of the rest of the identification document 1a, 1b.

The background pattern 10a, 10b has a strong contrast. For instance, the contrast ratio, that is the ratio between the maximum intensity and the minimum intensity is superior to 2:1. A pattern contrast ratio R is defined as:

$$R = ( max ( L 1 , L 2 ) + 0.05 ) / ( min ( L 1 , L 2 ) + 0.05 )$$

where L1 and L2 are the L channel values, that is the luminance, obtained after converting the color RGB image into a HSL (hue-saturation-luminance) image, for the foreground (1), for instance the motifs, and the background (2), that is the rest of the background pattern. Preferably, the pattern contrast ratio R is higher than 2.0:1, more preferably bigger than 3.0:1. Other metrics could include the root mean square (RMS) contrast, that is the standard deviation of pixel intensities normalized by the mean intensity. In another example, the histogram of pixel intensity is not homogenous, meaning here that the background pattern 10a, 10b comprises pixels with high variability in intensity.

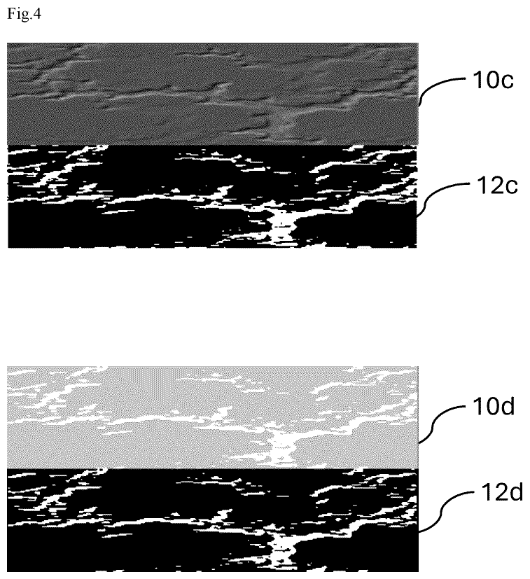

Preferably, the background pattern is designed as to produce a predictable binary result when the thresholding method proposed by Nobuyuki Otsu in “A threshold selection method from gray-level histograms”. IEEE Trans. Sys. Man. Cyber. 9 (1): 62-66.” is applied. In the examples illustrated in FIG. 4, the background pattern 10c is not considered as having a high contrast. Indeed, the motifs have blurred limits, and the binarized pattern 12c is not predictable. On the other hand, the background pattern 10d is usable for the application. That is, the foreground and background pixels are easily distinguished, and the binarized pattern 12d can be unambiguously determined.

Advantageously, the contrasting motifs are easily distinguishable using a copy with a quality lower than 400 DPI. It allows an authentication device to be able to match the identification document 1a, 1b with a mobile capture reliably, even if the mobile capture is of poor quality, for instance has blur.

The background pattern may be identical for several identification documents. The background pattern may vary between identification documents among a same category of identification documents or across several categories.

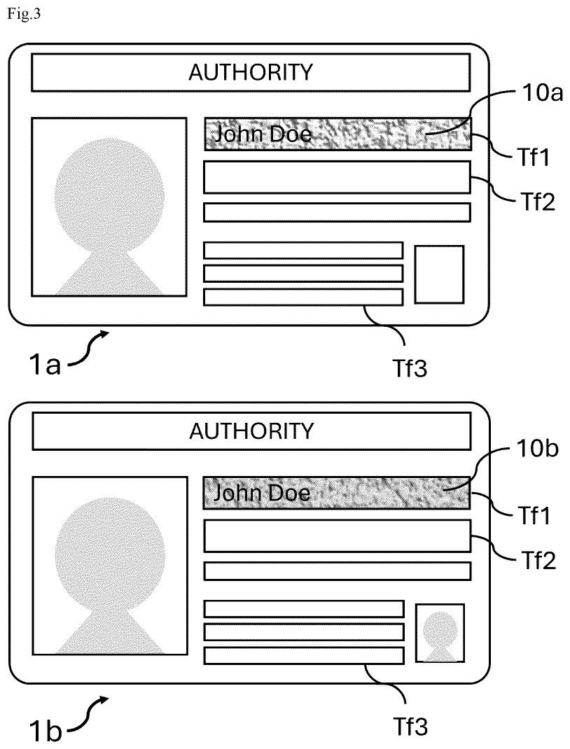

For instance, the exemplary document 1a on the top of FIG. 3 has a background pattern 10a with well-defined borders and higher contrast than the background pattern 10b of the document 1b on the bottom of FIG. 3.

Preferably, the background pattern 10a, 10b is not periodic, that is the contrasting motifs do not reproduce identically in different locations of the text field Tf1. This increases the reliability of the authentication method for documents obtained with the proposed manufacturing method, as will be described later.

The contrast between the background pattern 10a, 10b and the printed character must be sufficient i) for the identifying information to be human-readable and ii) for optical character recognition to be carried out successfully on an image of the identification document 1a, 1b. Typically, the identifying information is printed on top of the background pattern 10a, 10b with a dark color, near RGB=(0,0,0). Preferably, the printed characters of the identifying information have a contrast to noise ratio with the background pattern 10a, 10b superior to 4.5:1.

The pattern contrast ratio R defined above with L1 corresponding to the character and L2 corresponding to the background pattern is greater than 1.5:1, preferably more than 2.0:1, and more preferably bigger than 2.5:1.

The background pattern 10a, 10b can be printed before or after printing the identifying information. Preferably, the step S1 is carried out before the step S2, that is, the distinguishing background pattern is added behind the region where the identifying information may be printed for the considered text field. In the alternative embodiment where the background pattern 10a, 10b is printed on top of the identifying information, the background pattern 10a, 10b must be transparent enough such that the printed identifying information is human-readable. In particular, the transparency must be sufficient so that contrast to noise ratio of the printed characters compared to the printed background is superior to 4.5:1 or the pattern contrast ratio of the printed characters compared to the printed background is greater than 1.5:1, preferably more than 2.0:1, and more preferably bigger than 2.5:1.

Preferably, the background pattern 10a, 10b covers the entire region of the text field Tf1. By “entire region”, it is understood that the written identifying information fits in the background pattern 10a, 10b. In the illustrated embodiment, the background pattern 10a, 10b covers entirely the text field Tf1 comprising the full name. The background pattern 10a, 10b takes a rectangular form which width and length depends on the chosen text field Tf1.

An image of the identification document 1a, 1b with printed background pattern 10a, 10b and identifying information is acquired by the interface of the printing machine. The image may be a scanned image of the identification document 1a, 1b comprising at least the text field Tf1 of interest. Preferably, the image is acquired with a quality higher than 400 DPI.

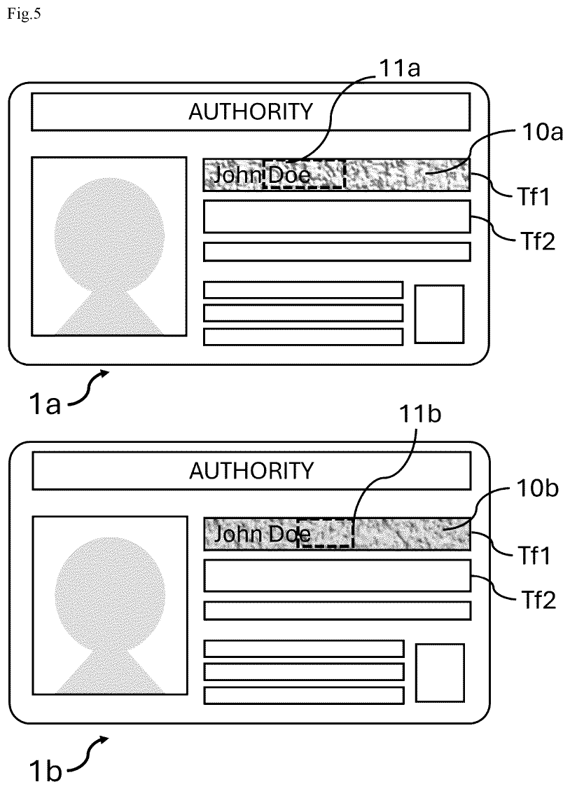

In reference to FIG. 5, during a step S3, the processor selects a pattern portion of the image of the identification document 1. The selected pattern portion 11a, 11b comprises at least one character of the identifying information and a part of the background pattern which covers the at least one character, meaning the background pattern can be either underlaying or overlaying the at least one character. In other words, the selected pattern portion 11a, 11b encompasses both the printed letter or number and some contrasting motifs surrounding the printed identifying information, for instance motifs next to the character or above or under the character, depending on the size of the motifs and the line spacing.

Typically, the selected pattern portion 11a, 11b is a rectangular patch covering the last letter of the identifying information and part of the background pattern surrounding the last letter, referred to as trailing blank space.

Alternatively, or in combination, the selected pattern portion comprises a randomly chosen character in the printed identifying information and part of the background pattern 10a, 10b above and under the chosen character. It is particularly appropriate if the line spacing is sufficient and the contrasted motifs of the background pattern are small enough to ensure that the selected pattern portion 11a, 11b includes contrasted motifs, as assessed for example by Otsu's thresholding method, as mentioned above. Preferably, the selected pattern portion 11a, 11b is included in the text field covered by the background pattern 10a, 10b, meaning that it does not comprise a part of the generic background of the identification document 1a, 1b.

Alternatively, or in combination, the selected pattern portion comprises more than one character of the identifying information. Preferably, the pattern portion 10a comprises a plurality of characters from the identifying information. The pattern portion 10a may comprise several adjacent characters or be composed of different portions comprising nonadjacent characters. In particular, the number of characters in the selected pattern portion depends on the available memory or data storage space. For instance, multiple letters from throughout the identifying information may be stored in addition to the last letter and trailing blank space.

In another embodiment, several background patterns are printed on several text fields, and a pattern portion is selected from each text field covered by a respective background pattern.

During a step S4, the processor encodes the selected pattern portion 11a into a machine-readable code. The selected pattern portion 11a can be encoded itself as a representation, for instance a pixel matric of binarized values. Preferably, the selected pattern portion 11a is encoded as a feature vector. This alternative does not require binarization and is known to be more color friendly, in an embodiment where the selected pattern portion is not converted to grayscale, the required memory space being easily as low as a few hundred bytes. Different methods can be used to extract features. For instance, Scale-Invariant Feature Transform (SIFT), Speeded Up Robust Feature (SURF), or KAZE generate string based descriptors, while Orientated FAST and Rotated BRIEF (ORB), binary robust invariant scalable keypoints (BRISK) or accelerated KAZE (AKAZE) generate binary descriptors. Feature matching can then be performed using L1-norm or L2-norm for string-based descriptors, or Hamming distance for binary descriptors, for instance. Other methods for feature matching include approximate nearest neighbors (FLANN) and exhaustive search, commonly known as Brute Force (BF) methods.

The machine-readable code may include a barcode, a quick-response (QR) code, or any other symbology code. The machine-readable code may encode personally identifying information of the holder of the identification document 1a. Barcodes are one-dimensional, which means that information can be scanned only horizontally. QR codes are two-dimensional, which means that information can be read both horizontally and vertically, allowing to store more data.

Typically, the pattern portion 11a is extracted from the image of the identification document 1a.

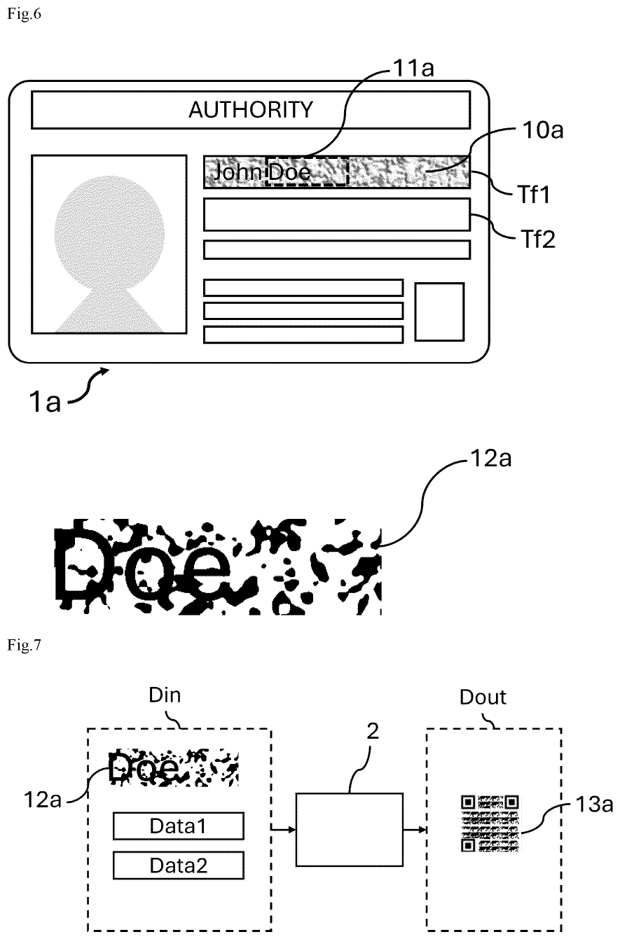

Optionally, in reference to FIG. 6, the selected pattern portion 11a is binarized to obtain a binarized pattern portion 12a. By “binarization”, it is meant that the pixels of the selected pattern portion 11a are set to two different values, for instance 0 or 1, after binarization. For instance, if the selected pattern portion 11a is in color, the selected pattern portion 11a is first converted to grayscale. Each pixel of the selected pattern portion 11a has a value between 0 (black) and 255 (white). Then, a binarization threshold value is selected. During binarization, any pixel value above the binarization threshold value is set a first value (usually 255 or 1 for white), and below to 0 (black). Using binarization allows to save memory space for later encoding into a machine-readable code. Preferably, the background pattern 10a is designed as to produce a predictable binary result when Otsu's Method for thresholding is applied, as mentioned above.

Preferably, the processor compresses the selected pattern portion 11a, 12a. This allows to limit the memory required to store the selected pattern portion 11a, 12a. Preferably, the selected pattern portion 11a, 12a is highly compressed, that is the memory space required to store the compressed pattern portion 11a, 12a is divided by a factor greater than 10. Preferably, the memory space required to store the compressed pattern portion 11a, 12a is less than 1 kbyte.

In an embodiment, the processor applies to the selected pattern portion 11a, 12a a lossy compression algorithm such as JPEG compression. However, since the selected pattern portion 11a, 12a comprises sharp edges associated with the text character, a lossy compression algorithm could cause visual distortions known as ringing effects. Preferably, the processor applies to the selected pattern portion 11a, 12a a lossless compression algorithm such as PNG compression. A lossless compression algorithm is particularly advantageous if the background pattern 10a is chosen such that simple preprocessing allows to reliably create a binary representation 12a of the text and background. For instance, a grayscale background pattern with high contrast of size 400×100 could be stored in PNG format on 2446 bytes. Using a compression in a grayscale bitmap pattern portion with a 1 byte-per-pixel representation would lead to 40,000 bytes. In this context, compression would be required, for instance using a 1 bit-per-pixel binary representation, supported by PNG, and reducing the image down to 1216 bytes. Another alternative being to crop that byte-per-pixel representation to 100×100 and save out the binary PNG, reducing the required memory space to 437 bytes.

Compression is particularly interesting in the embodiment where several background patterns for different text fields are used. Indeed, the storage space on the machine-readable code is limited. For instance, the storage capacity of a very high density QR-code is up to 1700 bytes but requires a dedicated document scanner to be decoded. On the other hand, a less dense QR-code is readable by other media such as a smartphone but has a storage capacity less than 1000 bytes.

Preferably, in reference to FIG. 7, the processor 2 further encodes metadata information Data1, Data2 into the machine-readable code 13a. In other words, the payload of the machine-readable code 13a allows to recover appropriate metadata and the binarized pattern portion 12a encoded in the QR-code 13a. For instance, the metadata information Data1, Data2 comprises the binarization threshold value, an indicator of which one or more text fields were selected, a location information such as the index of each selected character in the identifying information, the dimension of the selected pattern portion 11a or the location of an edge of the selected pattern portion. Advantageously, the metadata information may include a location information. For instance, the location information is stored as a label or index of the text field of interest, in the case where the text field of interest has a number printed next to it and comprises a start range and stop range of the character. In the case where trailing blank space is included in the pattern portion, the incremented stop range (stop range +1) could correspond to the trailing blank space. Alternatively, the location information is stored as a bounding box definition in pixels at 400 dpi defining the region of interest, that is the contour of the pattern portion inside the identification document.

As will be described later, metadata information may also include information useful for authentication of the document, for instance a suggested score threshold or security threshold or a suggested matching method.

Preferably, the machine-readable code is digitally signed. As explained before, the selected pattern portion 11a can be binarized before the digital signature is created, or the selected pattern portion 11a can be binarized and further compressed before the digital signature is created.

Typically, a single digital signature is calculated on all the data to be stored, comprising for instance multiple selected pattern portions and metadata as described above. The digital signature is then added to the payload before the machine-readable code is produced and printed on the identification document.

Adding a digitally signed signature to the machine-readable code allows to improve the security of the identification document 1a. Indeed, an attempt to spoof the document by modifying the machine-readable code would be detected. Only a verifying authority with a secure key can validate the information encoded on the machine-readable code accurately by matching it with a signing key.

In reference to FIG. 8, the printing machine then prints the machine-readable code on the identification document 1a. Here, the machine-readable code 13a is printed in the bottom right of the identification document 1a.

The machine-readable code may be printed in any adequate location of the identification document 1a, including a different face or page of the identification document 1a. The machine-readable code is shown here on the front of the document 1a, but it could be on the back if is too large to be displayed on the front of document with a card format. Alternatively, the printing machine may print the machine-readable code on a separate substrate that is then definitely attached, for instance glued, to the identification document 1a.

Preferably, the machine-readable code is at least partly or entirely printed with ultra-violet ink. This makes the machine-readable code less obvious on the identification document and harder to spoof. The security level is therefore improved. The machine-readable code printed with UV ink could be read by a scanner with multispectral illumination but could not be read by a mobile device. It also allows to print a machine-readable code in a bigger format without masking the text fields of the document. The machine-readable code printed in UV ink can be printed over the entire document. A large code is easier to be read by a scanner with multispectral illumination. It also implies that any alteration to a part of the document could potentially break the machine-readable code and lead to a negative result in the authentication. Alternatively, the machine-readable code is printed in UV ink on a ghost portrait of the identification document, that is on a smaller version of the original photo image on the document printed semi-translucent.

Preferably, the machine-readable code is printed on the identification document with a quality comprised between 200 DPI and 400 DPI. This quality level is standard such that the manufacturing method can be carried out by any printing machine for identification documents. Depending on the size of the compressed pattern portion payload, a high-density machine-readable code may be needed which could require printing resolution at or above the high end of this range. For instance, the high-density machine-readable code is printed with a quality comprised between 400 DPI and 600 DPI. As mentioned above, the high-density machine-readable code offers a higher storage capacity but requires specific scanners to be read.

The chosen quality level is sufficient for authentication, as will be described later.

According to another aspect, the identification document can be authenticated to identify the identity of the holder. The authentication method is carried out by an authentication system comprising a processor. The authentication system comprises a memory to store data, for instance security keys used to digitally sign the machine-readable codes or metadata information used for manufacturing the identification document. The memory is accessible by the processor. The memory stores a computer program comprising instructions to carry out the method for authentication described herein.

For example, the authentication system may be a scanning device, for instance at a border security check. The identification document may be received by the scanning device before boarding an international flight. The scanning device may comprise a scanner with photo-sensitive cameras to scan the front or back of the identification document under different lighting conditions such as visible light, infrared, and ultraviolet. The photo-sensitive cameras may include, for example, a charge-coupled device.

Alternatively, the authentication system may be a mobile device such as a mobile phone equipped with a camera owned by a security officer or agent. The authentication of the holder may be carried out for controlling access to a secured building or during a daily routine such as traffic control.

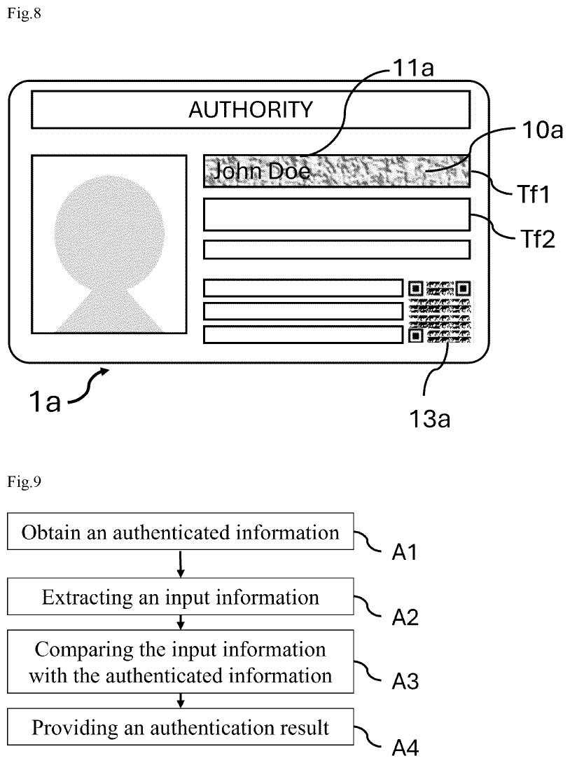

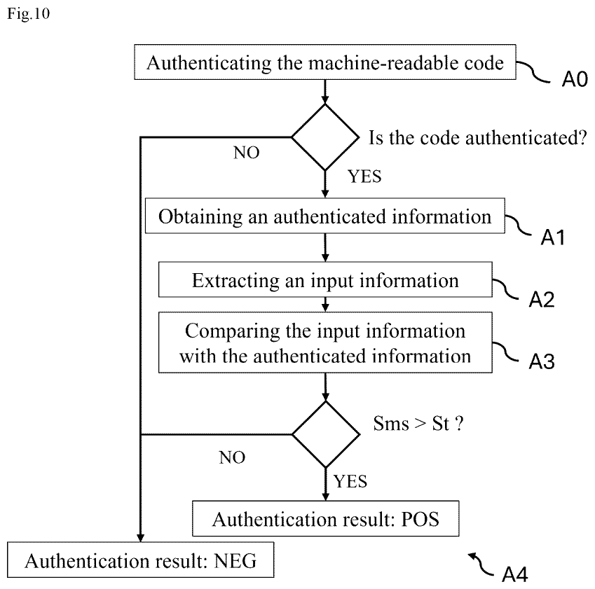

An identification document obtained using the proposed manufacturing method can then be authenticated using an authentication method as illustrated in FIGS. 9 and 10.

The authentication system first obtains an image representative of the identification document to be authenticated. The image of the identification document may comprise both the text field of interest and the machine-readable code. Alternatively, several images of the identification document may be acquired, for instance a first image comprising the machine-readable code, and a second image comprising the text field of interest. Here, the input document image comprises at least the QR-code 13a printed on the document and the text field Tf1. The input document image can be obtained using a scanner or a camera.

During a step A1, the authentication system obtains an authenticated information corresponding to a text field portion of the identification document, by decoding the machine-readable code. In other words, the machine-readable code may be scanned so that the encoded personally identifiable information of the holder of the identification document is extracted.

Preferably, during a preliminary step A0, the processor carries out an authentication of the machine-readable code by validating the digital signature used to encrypt the machine-readable code. This allows to accelerate the authentication method by directly outputting a negative authentication result if the digital signature is not validated. The processor may use encryption keys stored in the memory to validate the scanned machine-readable code.

During a step A2, the processor extracts an input information from the image of the identification document. The extracted input information comprises the text field portion of the identification document.

The extracted input information may correspond to a portion of the input document image. The portion typically corresponds to a slightly oversized rectangle of the input document image which includes the last letter of the text field of interest and the trailing blank space comprising the background pattern. Preferably, the extracted input information also comprises additionally stored characters. For instance, the processor may implement optical character recognition (OCR). After OCR processing on the input information, the location of the last character and any additionally stored characters of the identifying information in the text field of interest is known.

The memory of the authentication system may store an information related to the position of the pattern portion to be authenticated. Alternatively, the information can be stored on a memory accessible by the authentication system. The information comprises for instance the text field of interest or the dimensions of the pattern portion used when manufacturing the identification document.

In addition, or alternatively, the information is embedded in the machine-readable code printed on the identification document to authenticate. The information is then recovered by reading the machine-readable code directly. This is particularly advantageous in an embodiment where the text field of interest or the selected pattern portion vary for a category of identification documents.

During a step A3, the processor of the authentication system compares the extracted input information with the authenticated information.

The comparison results in a similarity match score Sms. The similarity match score Sms is computed by the processor from the extracted input information and the authenticated information by template matching. For instance, the similarity match score Sms is one among a correlation coefficient, a sum-of-squared-difference, or a cross-correlation. Some template match measures, such as sum-of-squared-difference, may natively provide numerically smaller scores for better matches. In such cases, the similarity match score is preferably converted from a distance-score to a similarity score, for example by using a normalizing version of the metric to obtain a normalized difference score in the range [0.0, 1.0] and then computing the difference between 1.0 and the obtained normalized difference score.

In the embodiment where features of the selected pattern portion are encoded in the machine-readable code, instead of performing a template match, similar features from the input image can be extracted during step A3 and a feature match is performed.

Preferably, the processor implements a scaling algorithm before comparison to ensure that the extracted input information is scaled to the same effective DPI than the authenticated information, that is the pattern portion encoded in the machine-readable code. This allows to improve the reliability of the similarity match score Sms.

Preferably, during the extraction of the input information, if any preprocessing has been applied to the text field portion, such as thresholding for binarization, the same operations are applied to the input information.

Preferably, computing the similarity match score is done in grayscale or in black-and-white, that is with binarized images. It increases reliability of the similarity match score, since lighting variations in mobile capture environments can make color presentation in digital images of documents inconsistent and color pattern matching less reliable.

For instance, in an embodiment wherein the authenticated information is a grayscale image, the processor converts the extracted input information into a grayscale image before comparison.

For instance, in an embodiment wherein the authenticated information is a black and white image, the authentication system first obtains the binarization threshold value. The binarization threshold value can be recovered by reading the machine-readable code or stored in the memory of the authentication system. Then, the processor converts the extracted input information into a black and white image based on the binarization threshold value before comparison.

In an embodiment where several background patterns are used on different text fields, and several pattern portions are selected and stored on the machine-readable code, the previous steps are iterated for each of the stored pattern portion. In other words, each stored pattern portion is matched against its corresponding search area individually.

Preferably, if the quality of the extracted input image is below a quality threshold, the authentication system provides a warning to an interface indicating that the comparison cannot be run and reports an inconclusive authentication. In this case, the operator running the authenticating system might provide a new input image to extract an input information of higher quality.

During a step A4, the authentication system provides an authentication result based on the similarity match score Sms.

For instance, the authentication result is positive, that is the input document passes the authentication test if the similarity match score Sms is greater than a security threshold value St; or the authentication result is negative, that is the input document is not authenticated, if the similarity match score Sms is below the security threshold value St. The security threshold value may be stored in the memory of the authentication system. Alternatively, the security threshold can be encoded inside the machine-readable code as part of the metadata information. In this case, the security threshold value is obtained subsequently to step A1 when reading the machine-readable code.

The threshold may vary between different card designs. It may be fixed or vary with the category of identification documents. Preferably, the security threshold value may vary with the nature of the machine-readable code. For instance, in an embodiment where the machine-readable code is a 2D barcode with limited storage capacity, the authenticated information is of low resolution due to high compression before encoding. In this context, the security threshold is lower than the security threshold that could be used in an embodiment where the machine-readable code is a QR code with higher storage capacity and authenticated information of better resolution.

In the embodiment where several background patterns are used, preferably all the similarity match scores have to be superior to the corresponding security threshold to output a positive authentication result that is to constitute a successful authentication of the document.

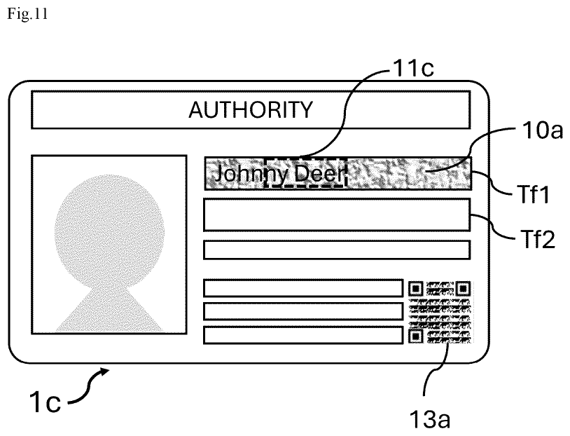

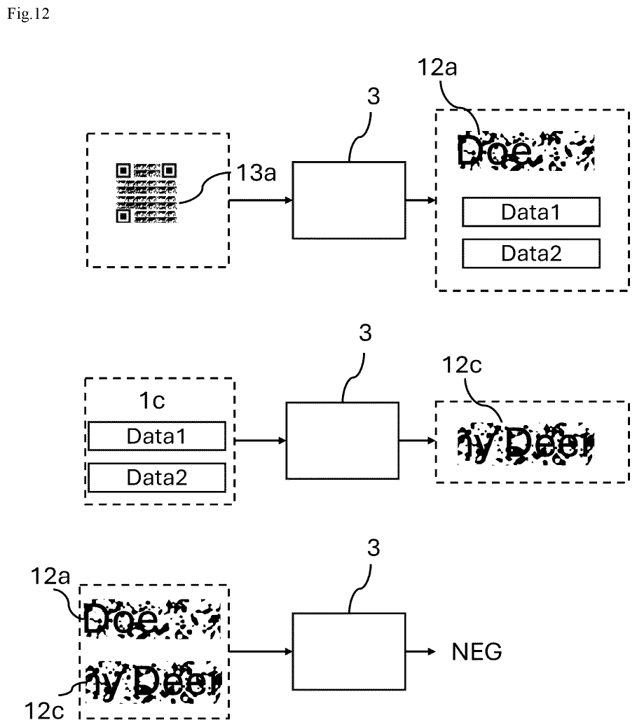

As is illustrated in FIGS. 11 and 12, one benefit of the proposed methods is that it is based on a common document design for all holders, but the selected pattern portion is unique for most holders based on the length of their identifying information and the selected character in the text field of interest.

FIGS. 11 and 12 illustrate the reliability of the proposed authentication method, in a case where a fraudster starts with the document 1 obtained using the manufacturing method starting from the generic document illustrated on FIG. 1 and the secured document 1a on FIG. 8.

To obtain the falsified document 1c represented on FIG. 11, the fraudster here scrubbed the original name “John Doe” and then substituted it a longer name “Johnny Deer”. It results in the visually reasonable looking identification document 1c, such that the falsified document 1c could pass checks relying on static patterns only, or even tests based on data crosscheck, if the fraudster also knows how to spoof other related data sources such as machine-readable zones (MRZ).

FIG. 12 illustrates the different steps of the authentication method in this case.

The processor 3 recovers the binarized pattern portion 12a and metadata information Data1, Data2 by reading the QR code 13a. Preferably, the digital signature of the QR-code 13a is verified beforehand. If the verification of the QR-code 13a fails, the document 1c cannot be authenticated. An error or a negative authentication result is raised to the monitor. Else, if the verification of the QR-code 13a succeeds, the recovered initial selected pattern portion is considered as safe. The authentication of the QR-code advantageously occurs before further processing. It allows to gain time and not compute the similarity match score.

Using the metadata information Data1, Data2 and the image of the falsified document 1c, the processor 3 extracts a corresponding pattern portion and apply a binarization to obtain the input information 12c. Next, Then, the recovered pattern portion is template-matched with the selected portion of the input document image. The processor 3 compares the authenticated information 12a corresponding to the initial binarized selected pattern portion and the input information 12c corresponding to the binarized selected pattern portion of the falsified document 1c.

In the illustrated case, the newly selected pattern region includes different characters since the new name is longer. Therefore, the position of the last letter of the name text field changed.

Using the proposed authentication method, the authentication result is negative, due to the low value of the similarity match score between the selected patterns. Indeed, the two pattern portions do not match. The processor 3 outputs to the monitor a negative authentication result, and the falsified document 1c is not authenticated.

In another case where the processor 3 uses OCR to detect the location of the last character and where the selected pattern portion comprises the last character and the trailing blank space, the background pattern is also different since the total length of the identifying information has changed. Therefore, the two pattern portions do not match, and the document is not authenticated.

This authentication method is particularly robust to changes in the identifying information that make the printed text in the text field of interest shorter or longer. In both cases, even if the new text ends with the same character as the original, a different section of the background pattern will be captured when sampling at a different location in the text field of interest. Attempts to use an alternate font or different font size to retain the same length with a different number of characters should also be detected with this approach because the shape of the last character in the text field will no longer match the one stored in the initial selected pattern portion.

1. A method for manufacturing an identification document, comprising:
printing a background pattern on the identification document, the background pattern including contrasting motifs covering at least partly a text field of the identification document;
printing identifying information in the text field, wherein the identifying information includes one or more characters;
selecting a pattern portion of an image of the identification document, the pattern portion including at least one character of the identifying information and a part of the background pattern which covers the at least one character;
encoding the selected pattern portion into a machine-readable code; and
printing the machine-readable code on the identification document.

2. The method for manufacturing the identification document according to claim 1, wherein the contrasting motifs of the background pattern do not cover the text field periodically.

3. The method for manufacturing the identification document according to claim 1, wherein the at least one character is the last character of the identifying information, and the selected pattern portion includes a portion of the text field which follows the last character.

4. The method for manufacturing the identification document according to claim 1, wherein encoding the selected pattern portion includes binarizing the selected pattern portion using a binarization threshold.

5. The method for manufacturing the identification document according to claim 1, further comprising encoding metadata information into the machine-readable code before printing the machine-readable code on the identification document, the metadata information including at least one among a location information of the selected pattern portion in the identification document, and a security threshold for authentication of the identification document.

6. The method for manufacturing the identification document according to claim 1, further comprising cryptically signing the machine-readable code before printing the signed machine-readable code on the identification document.

7. The method for manufacturing an identification document according to claim 1, wherein the machine-readable code is printed on the identification document with a quality between 200 DPI and 400 DPI.

8. The method for manufacturing the identification document according to claim 1, wherein the machine-readable code is printed at least partly with ultraviolet ink.

9. The method for manufacturing the identification document according to claim 1 wherein the machine-readable code is a QR code.

10. An identification document comprising:
at least a text field in which an identifying information is printed,
wherein the identifying information includes one or more characters and wherein a background pattern is printed on the identification document, the background pattern including contrasting motifs covering at least partly the text field, and
wherein a machine-readable code is printed on the identification document, the machine-readable code encoding a pattern portion of an image of the identification document which includes at least one character of the identifying information and a part of the background pattern which covers the at least one character.

11. The identification document of claim 10, wherein the identification document is a personal identification document selected from among a personal identity card, a driving license, and a passport.

12. The identification document of claim 10, wherein the identification document is a document to identify a product or an animal.

13. A method for authenticating an identification document having at least a text field in which an identifying information is printed, wherein the identifying information includes one or more characters and wherein a background pattern is printed on the identification document, the background pattern including contrasting motifs covering at least partly the text field, and wherein a machine-readable code is printed on the identification document, the machine-readable code encoding a pattern portion of an image of the identification document which includes at least one character of the identifying information and a part of the background pattern which covers the at least one character, the method comprising:
obtaining an authenticated information corresponding to a text field portion of the identification document, by decoding the machine-readable code;
extracting an input information from an image of the identification document, the extracted input information comprising the text field portion of the identification document;
comparing the extracted input information with the authenticated information, the comparison resulting in a similarity match score; and
providing an authentication result based on the similarity match score.

14. The method for authentication according to claim 13, further comprising:
obtaining a location information by reading the machine-readable code, and wherein the input information is extracted based on the location information.

15. The method for authentication according to claim 13, wherein the authenticated information is a grayscale image, and wherein the method further comprises converting the extracted input information into a grayscale image before comparison.

16. An authentication system comprising:
a processor configured to carry out authentication of an identification document having at least a text field in which an identifying information is printed, wherein the identifying information includes one or more characters and wherein a background pattern is printed on the identification document, the background pattern including contrasting motifs covering at least partly the text field, and wherein a machine-readable code is printed on the identification document, the machine-readable code encoding a pattern portion of an image of the identification document which includes at least one character of the identifying information and a part of the background pattern which covers the at least one character by the processor being configured to:
obtain an authenticated information corresponding to a text field portion of the identification document, by decoding the machine-readable code;
extract an input information from an image of the identification document, the extracted input information comprising the text field portion of the identification document;
compare the extracted input information with the authenticated information, the comparison resulting in a similarity match score; and
provide an authentication result based on the similarity match score.

17. The method for manufacturing the identification document according to claim 1, wherein the machine-readable code is printed at least partly with ultraviolet ink on a ghost portrait of the identification document.

18. The method for manufacturing the identification document according to claim 2, wherein encoding the selected pattern portion includes binarizing the selected pattern portion using a binarization threshold.

19. The method for manufacturing the identification document according to claim 3, wherein encoding the selected pattern portion includes binarizing the selected pattern portion using a binarization threshold.

20. The method for manufacturing the identification document according to claim 2, further comprising encoding metadata information into the machine-readable code before printing the machine-readable code on the identification document, the metadata information including at least one among a location information of the selected pattern portion in the identification document, and a security threshold for authentication of the identification document.
